(19) United States
(12) Patent Application Publication
(10) Pub. No.: US 2025/0165938 A1
(43) Pub. Date: May 22, 2025

(54) System and method for facilitating digital currency transactions

(71) Applicant: Veinticuatro Pty Ltd, Rydalmere, New South Wales (AU)

(72) Inventor: Anshul Saini, Rydalmere (AU)

(73) Assignee: Veinticuatro Pty Ltd, Rydalmere, New South Wales (AU)

(21) Appl. No.: 18/862,105

(22) PCT Filed: May 2, 2023
(86) PCT No.: PCT/AU2023/050367

§ 371 Date: Oct. 31, 2024

(30) Foreign Application Priority Data
May 2, 2022 (AU) 2022901147

(51) Int. Cl. G06Q 20/10; G06Q 20/22; G06Q 20/36; G06Q 20/38

(52) U.S. Cl. CPC G06Q 20/10; G06Q 20/227; G06Q 20/36; G06Q 20/381

(57) ABSTRACT

There is provided a computer-implemented method for facilitating a transfer of funds of a selected digital currency, the funds being transferred from one of a plurality of payer digital wallets, each of the plurality of payer digital wallets configured to store funds defined by a respective different one of a plurality of digital currencies.

### TECHNICAL FIELD

The present disclosure relates to computer-implemented method, software and system for the management of digital wallets to facilitate the payment of digital funds to a payee.

### BACKGROUND

Computer implemented payment systems facilitate the payment of funds from a payer to a payee. Payment systems may facilitate payment of funds that are defined in terms of a fiat currency, or funds that are defined in terms of a digital currency such as a cryptocurrency.

Many cryptocurrencies currently exist, with many new cryptocurrencies becoming available year on year. Increasingly, payees are electing to receive a payment in cryptocurrency. Exchange rates between cryptocurrencies, and between cryptocurrencies and fiat currencies often fluctuate over time, and can be quite volatile.

Accordingly, there is a need for improved payment systems which facilitate the payment of cryptocurrency funds to a payee. Furthermore, there is a need to provide an improved method of facilitating payment of cryptocurrency funds to ameliorate the effects of the exchange rate volatility that can be a characteristic of cryptocurrencies.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In this specification, a statement that an element may be “at least one of” a list of options is to be understood to mean that the element may be any one of the listed options, or may be any combination of two or more of the listed options.

### SUMMARY

Provided herein is a method and system to facilitate the payment of funds to a user in a cryptocurrency selected by the user. The present technology provides for the management of a plurality of digital payer wallets, each payer wallet configured to hold funds of a different cryptocurrency. Furthermore, the present technology provides for the prompt and efficient replenishment of funds to the payer wallets, to ameliorate the effects of exchange rate volatility.

According to one aspect of the present technology, there is provided herein a computer-implemented method for facilitating a transfer of funds of a selected digital currency, the funds being transferred from one of a plurality of payer digital wallets, each of the plurality of payer digital wallets configured to store funds defined by a respective different one of a plurality of digital currencies. The method comprises determining a payable amount, the payable amount being defined in a first currency, determining an indication of a selected digital currency, and selecting one of the plurality of payer digital wallets based on the selected digital currency, the selected payer digital wallet being configured to store digital funds defined by the selected digital currency. The method further comprises receiving an indication of a payee digital wallet, the payee digital wallet configured to store funds defined by the selected digital currency, determining, based on the payable amount defined in the first currency, a converted payable amount defined in the selected digital currency, and transferring the converted payable amount from the selected digital wallet to the payee digital wallet.

In one embodiment, determining a converted payable amount defined in the selected digital currency comprises determining an exchange rate between the first currency and the selected digital currency.

In one embodiment, the method further comprises transmitting a first purchase order for the converted payable amount to a digital currency exchange, transferring a second amount from the selected digital wallet to a second payee digital wallet, transmitting a second purchase order for the second amount to the digital currency exchange, and in response to a withdraw trigger, withdraw a withdrawal amount from the digital currency exchange to the digital wallet, the withdrawal amount being associated with the first purchase order and the second purchase order.

In one embodiment, the selected digital currency comprises a cryptocurrency. In one embodiment, the first currency is a fiat currency.

In one embodiment, the transfer of the converted payable amount from the selected digital wallet to the payee digital wallet is recorded in a distributed ledger.

According to another aspect of the present technology, there is provided a computer-implemented method for managing a digital wallet. The method comprises transferring a first amount from a payer digital wallet to a first payee digital wallet, transmitting a first purchase order for the first amount to a digital currency exchange, transferring a second amount from the payer digital wallet to a second payee digital wallet, and transmitting a second purchase order for the second amount to the digital currency exchange. The method further comprises in response to a withdraw trigger, withdrawing a withdrawal amount from the digital currency exchange to the payer digital wallet, the withdrawal amount being associated with the first purchase order and the second purchase order.

In one embodiment, the withdraw trigger comprises any one or a combination of a time of the day, a number of payments made from the payer digital wallet, a total amount of transfers from the payer digital wallet, a balance associated with the payer digital wallet, a cost associated with withdrawing the withdrawal amount from the digital currency exchange, or an indication that a balance of digital funds stored by the digital wallet is less than a minimum balance of digital funds.

In one embodiment, the payer digital wallet is configured to store funds defined by a cryptocurrency. In one embodiment, the first payee digital wallet is the same as the second payee digital wallet.

In one embodiment, each of the plurality of payer digital wallets is associated with a respective maintenance amount of digital funds in the digital currency associated with the respective payer digital wallet.

In one embodiment, the method further comprises, in response to transferring the converted payable amount from the selected payer digital wallet to the payee digital wallet, facilitate a transfer of funds to the selected payer digital wallet to ensure an amount of funds stored by the selected payer digital wallet is equal to, or exceeds, the maintenance amount associated with the selected payer digital wallet.

In one embodiment, the method further comprises a validation process. The validation process comprises receiving a payment request, performing a validation process, and in response to performing the validation process, providing an indication of validation to the processor.

In one embodiment, the method further comprises, in response to receiving an indication of validation from the validation component, transferring the converted payable amount from the selected digital wallet to the payee digital wallet.

According to another aspect of the present technology, there is provided a system for managing a digital wallet. The system comprises a payer digital wallet configured to store digital funds, an interface to a digital currency exchange, and a processor, The processor is configured to transfer a first amount from the payer digital wallet to a first payee digital wallet, transmit a first purchase order for the first amount to the digital currency exchange via the interface, transfer a second amount from the payer digital wallet to a second payee digital wallet, and transmit a second purchase order for the second amount to the digital currency exchange via the interface. The processor is further configured to, in response to a withdraw trigger, withdraw a withdrawal amount from the digital currency exchange to the payer digital wallet, the withdrawal amount being associated with the first purchase order and the second purchase order. In one embodiment, the processor is further configured to generate the withdraw trigger.

According to another aspect of the present technology, there is provided a system for facilitating a transaction. The system comprises a plurality of payer digital wallets, each of the plurality of payer digital wallets configured to store digital funds defined by a respective different one of a plurality of digital currencies, and a processor. The processor is configured to determine a payable amount, the payable amount being defined in a first currency, determine an indication of a selected digital currency, and select one of the plurality of payer digital wallets based on the selected digital currency, the selected payer digital wallet being configured to store digital funds defined by the selected digital currency. The processor is further configured to receive an indication of a payee digital wallet, the payee digital wallet configured to store funds defined by the selected digital currency, determine, based on the payable amount defined in the first currency, a converted payable amount defined in the selected digital currency, and transfer the converted payable amount from the selected payer digital wallet to the payee digital wallet. In one embodiment, the selected digital currency comprises a cryptocurrency.

In one embodiment, the system further comprises a plurality of cryptocurrency nodes, each of the plurality of cryptocurrency nodes associated with a respective one of the plurality of payer digital wallets.

According to another aspect of the present technology, there is provided a computer program comprising machine-readable instructions to cause a processing device to implement any one of the methods described above.

### BRIEF DESCRIPTION OF DRAWINGS

One or more implementations of the invention will now be described with reference to the accompanying drawings, in which:

FIG. 1 schematically illustrates a payment system, in accordance with an embodiment;

FIG. 2 illustrates a method to facilitate payment of a digital funds to a wallet associated with a user, in accordance with an embodiment;

FIG. 3 illustrates a payment method to facilitate payment of a payable amount to a user, in accordance with an embodiment;

FIG. 4 illustrates a purchase method to submit purchase orders for digital currency with a currency exchange, in accordance with an embodiment;

FIG. 5 illustrates a withdraw method to withdraw digital currency from a currency exchange, in accordance with an embodiment; and

FIG. 6 illustrates an API architecture for a plurality of blockchain nodes, each associated with a cryptocurrency, according to an embodiment.

### DESCRIPTION OF EMBODIMENTS

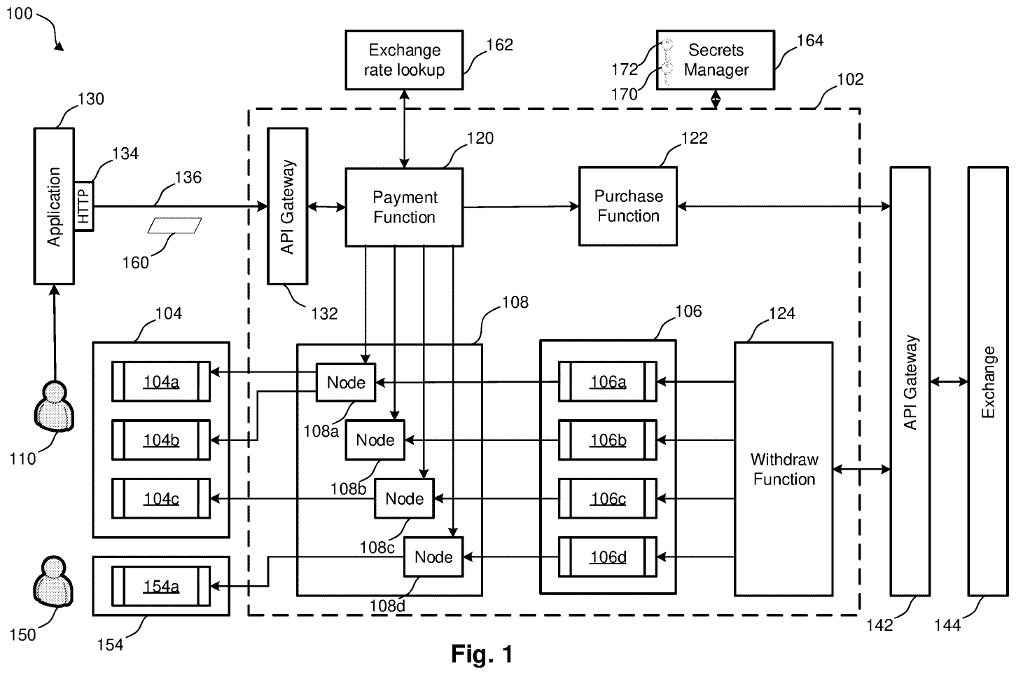

### FIG. 1—System Architecture

FIG. 1 schematically illustrates a payment system 102, in accordance with an embodiment. The payment system 102 is configured to facilitate payments of digital currency from digital wallets maintained by the payment system, to digital wallets associated with one or more users. The payment system 102 is configured to facilitate payments upon receiving a payment request 160 from a system application 130. Further, the payment system 102 is configured to manage the balance of digital wallets maintained by the payment system, and to facilitate the replenishment of the digital wallets with funds obtained from a digital currency exchange 144.

### Digital Wallets

The payment system 102 is configured to facilitate the transfer of funds from a digital wallet maintained by the payment system to a digital wallet associated with a user. Digital wallets (also referred to as wallet data structures) are configured to store digital currency. In some embodiments, the digital currency comprises a cryptocurrency. In some embodiments, the digital currency comprises a Central Bank Digital Currency (CBDC). In some embodiments, the digital currency comprises a digital fiat currency.

The digital wallet can comprise an indication of an account in which digital currency is stored. With regard to digital wallets and digital currency, the storage of an amount of currency does not refer to a physical storage of the currency. Rather, digital currency is stored in an account by virtue of an entry in a ledger which associates an amount of a digital currency with the account. With regard to cryptocurrencies, the amount of cryptocurrency stored in the account may be adjusted by a withdrawal or deposit action that is recorded in the distributed ledger associated with the cryptocurrency.

The digital wallet can further comprise a key pair (a public key and a private key). Ownership of the digital currency stored by the wallet can be demonstrated with knowledge of the private key associated with the wallet account. The key pair may be used to validate the authenticity of withdraws and deposits to a cryptocurrency account using asymmetric encryption. With knowledge of the public key associated with an account, an entity can deposit funds in the account. With knowledge of the private key associated with the account, an entity can determine the balance of funds within an account, and access (e.g. withdraw) the funds in the account. A digital wallet can provide secure storage for the private key.

References herein to a digital wallet ‘holding’ an amount of digital currency refers to the wallet retaining or having access to a private key which enables the user of the wallet to perform transactions or withdraw funds from the account associated with the digital wallet.

### System Wallet Manager

The payment system 102 comprises a system wallet manager 106. The system wallet manager 106 comprises four digital wallets 106a to 106d. The digital wallets 106a-d are referred to a system wallets, payer wallets, or payer digital wallets.

In the embodiment illustrated in FIG. 1, each of the system wallets 106a-d is configured to hold a different cryptocurrency. For example, system wallet 106a is configured to hold Zilliqa coins, system wallet 106b is configured to hold XRP coins, system wallet 106c is configured to hold IOTA coins, and system wallet 106d is configured to hold Doge coins.

In another embodiment, the system wallets may be configured to hold virtual funds of digital currencies or other cryptocurrencies. In some embodiments, the system wallet manager 106 comprises a plurality of system wallets configured to hold funds of the same cryptocurrency.

Each of the system wallets 106a to 106d is configured to hold at least a maintenance balance of the cryptocurrency associated with the system wallet. The maintenance balance for each system wallet may be defined by system settings of the payment system. The maintenance balance for any of the system wallets may be adjusted during operation of the payment system. The maintenance balance may differ from one system wallet to another system wallet. The maintenance balance of cryptocurrency in the system wallet provides an initial buffer of funds to pay users, such as user 110.

In the embodiment illustrated in FIG. 1, each of the system wallets is initialised with a maintenance balance of funds in the cryptocurrency associated with the wallet. More specifically, system wallet 106a is initialised with a maintenance balance of 200,000 Zilliqa coins (ZILs), system wallet 106b is initialised with a maintenance balance of 150,000 XRP coins (XRPs), system wallet 106c is initialised with a maintenance balance of 250,000 IOTA coins (MIOTA) and system wallet 106d is initialised with a maintenance balance of 100,000 DogeCoin coins (Doge).

The maintenance balance of coins in each system wallet is configured to provide a working buffer of coins to be paid out by the payment system 102 during operation. In one embodiment, the payment system selects maintenance balance for a system wallet based on the expected popularity of the cryptocurrency associated with the system wallet.

### User Wallet Manager

A user 110 (otherwise referred to as a payee) of the payment system 102 is associated with a user wallet manager 104. The user wallet manager 104 is configured to manage one or more electronic wallets. In accordance with FIG. 1, the user wallet manager 104 manages three electronic wallets 104a, 104b and 104c. Each of the user wallets 104a-c is configured to hold funds of a digital currency. User wallets are configured to receive funds from the payment system 102.

In other embodiments, a user 110 may be associated with a plurality of user wallet managers. Furthermore, in other embodiments, a user wallet manager may be associated with one, or a plurality of electronic wallets.

In accordance with the embodiment illustrated in FIG. 1, user wallets 104a and 104b are both configured to hold coins of the Zilliqa cryptocurrency. User wallet 104c is configured to hold coins of the IOTA digital currency.

A second user 150 is associated with a second wallet manager 154. User wallet manager 154 is associated with a user wallet 154a, which is configured to hold coins of the Doge cryptocurrency.

### Transfer of Digital Currency

The payment system 102 facilitates the transfer of digital currency from a system wallet to a user wallet. A digital currency may be either centralised, where there is a central point of control over the currency, or decentralised. One form of a decentralised digital currency is a cryptocurrency. In accordance with some embodiments, a cryptocurrency is an electronically transferrable digital asset that uses cryptography to secure transactions. Cryptocurrencies do not have a central issuing or regulating authority. Instead, cryptocurrencies use a decentralised system of ledgers to record transactions in a blockchain, and issue units of currency. Units of currency may be referred to as ‘coins’.

A blockchain is an electronic ledger which is implemented as a computer-based decentralised, distributed, peer-to-peer system made up of blocks which in turn are made up of transactions. Each transaction is a data structure that encodes the transfer of control of a digital asset between participants in the blockchain system, and includes at least one input and at least one output. Each block contains a hash of the previous block to that blocks become chained together to create a permanent, unalterable record of all transactions which have been written to the blockchain since its inception.

The transaction costs associated with transferring an amount of cryptocurrency from one party to another party may be substantially less than the transaction costs associated with transferring an equivalent amount of a fiat currency from the one party to the other party. In some situations, there is no transaction cost associated with the transfer of an amount of cryptocurrency. This low, or non-existent, transaction cost overhead may facilitate the cost-effective transfer of micro-payments of cryptocurrency from one party to another party. A micro-payment may comprise a payment of a very small amount of cryptocurrency; for example, less than 1 US dollar, or even less than 1 US cent.

Accordingly, for embodiments in which the payment system 102 is requested, by the system application 130, to process a large volume of micro-payments, the payment of the micro-payments in the form of cryptocurrency may substantially ameliorate the adverse effects of transactions costs associated with the large volume of payment transactions.

### Blockchain Nodes

In order for a transaction to be written to the blockchain, it must be “validated” by a blockchain node. Blockchain nodes perform work to ensure that each transaction is valid, with invalid transactions rejected from the network. If the transaction is found to be valid by the nodes, the transaction may be written to the blockchain, and the digital asset is thereby transferred from a payer digital wallet to a payee digital wallet.

The payment system 102 interfaces with a plurality of blockchain nodes 108a-d. Each of the blockchain nodes 108a-d is configured to maintain a copy of a blockchain ledger associated with a cryptocurrency. Furthermore, each of the blockchain nodes 108a-d is configured to communicate with other blockchain nodes associated with the cryptocurrency. A blockchain node may function as a client software function which facilitates the transfer of funds of a cryptocurrency from a payer wallet to payee wallets. With regard to the payment system 102, each of the blockchain nodes 108a-d facilitate the transfer of cryptocurrency funds from a respective one of the system wallets 106a-d to a user wallet.

For example, blockchain node 108a facilitates the transfer of Zilliqa coins from system wallet 106a to user wallets 104a and 104b. Blockchain node 108d facilitates the transfer of Doge coins from system wallet 106d to user wallet 154a.

In some embodiments, the blockchain nodes are comprised within the payment system. In other embodiments, the blockchain nodes comprise a third party software service with which the payment system interfaces.

For some embodiments it is advantageous for the blockchain nodes to be comprised within the payment system, instead of comprising a third party software service with which the payment system relies upon to process currency transactions. One reason for this advantage is a financial advantage. Some third party node providers charge for each Application Programming Interface (API) request, and some third party node providers charge a set amount for a specific number of transactions. Furthermore, if the payment system relies upon third party node providers, the payment system may be required to send sensitive information, such as private keys, to sign a transaction to a third party node provider. Additionally, third party nodes may experience downtime which can adversely affect the performance of the payment system.

### Gas Fees

In some embodiments, when the payment system sends currency transaction to the blockchain, the payment system pays a ‘gas price’ for the transaction to be approved/validated/sent on the blockchain network. Each blockchain provides the relevant APIs to calculate the current minimum gas price to send a transaction. When sending a transaction, the payment system pulls in the amount of minimum gas fees charged by the blockchain specific APIs.

### System Application

Interfacing with the payment system 102 is a system application 130. The system application includes a user interface via which users 110 and 150 may interact with the system application 130. In response to a user interacting with the system application 130, the system application 130 may trigger the payment system 102 to perform a payment transaction to transfer a payment of an amount of digital currency to the user.

In one embodiment, the system application 130 is configured to provide payment to a user in response to the system application obtaining a product from the user, or in response to the user performing a service. For example, the system application 130 may comprise a digital commerce platform in which the users 110 and 150 provide services to clients (not shown) of the system application 130. In exchange for the completion of a service by a user, the system application 130 causes the payment system 102 to provide payment to the user.

In another example, the system application 130 may comprise a salary management application which provides salary payments to users 110 and 150. In accordance with an salary contract (not shown), the system application 130 provides payment requests to the payment system 102, which cause the payment system to provide payment to the users 110 and 150.

In another example, the system application 130 may comprise an information analytics platform which collects data from users. The system application 130 causes the payment system 102 to provide payment to users 110 and 150 in exchange for data provided to the system application 130 by users 110 and 150.

### API Gateway

The system application 130 causes the payment system 102 to provide payment to a user by transmitting a payment request 160 to the payment system 102.

The payment system 102 comprises an application programming interface (API) gateway 132. The API gateway 132 is a software intermediary via which the payment system 102 receives requests from the system application 130 to perform payment transactions.

In one embodiment, the system application 130 comprises a HTTP endpoint 134 through which the system application 130 transmits the payment request 160 to the API gateway 132 of the payment system.

The API gateway 132 interfaces with the payment manager 120 of the payment system 102. The payment manager 120 comprises a software module configured to manage payment of digital funds to the user wallets 104a-c and 154a.

### Payment Request

The payment request 160 comprises parameters which define the payment to be made to the user. In one embodiment, the payment request parameters comprise a user identification code which uniquely identifies the user 110, and a payable amount defined in the base currency.

In one embodiment, the payment request comprises an indication of a digital currency in which to make payment to the user 110. In one embodiment, the digital currency is a user selected currency.

In one embodiment, the system application 130 provides the user 110 with a plurality of digital currencies in which the payment system 102 can make a payment to a wallet associated with the user 110.

The system application 130 obtains from the user 110 a, via the user interface, selection of the user's preferred digital currency. In one example, the system application 130 displays, in a graphical user interface (GUI), to the user 110, a selection of four digital currencies (e.g. Doge, Bitcoin, Zilliqa and XRP).

In one embodiment, the user selects one or more currencies via the user interface of the system application 130. The user interface may prompt the user to select a plurality of currencies. The user interface may enable the user to rank the plurality of user selected currencies to indicate a preference order in which the user is to be paid.

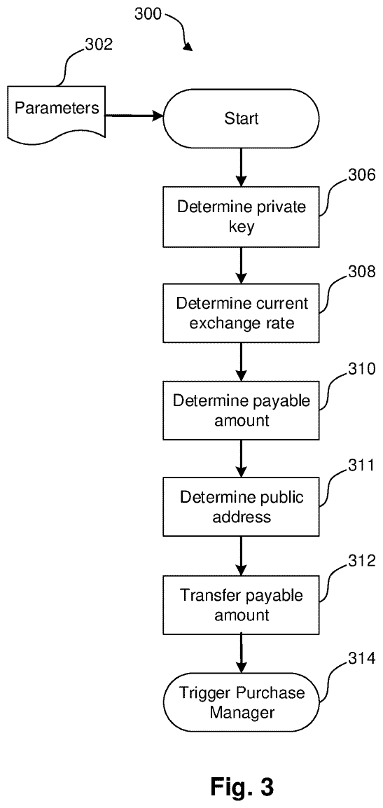

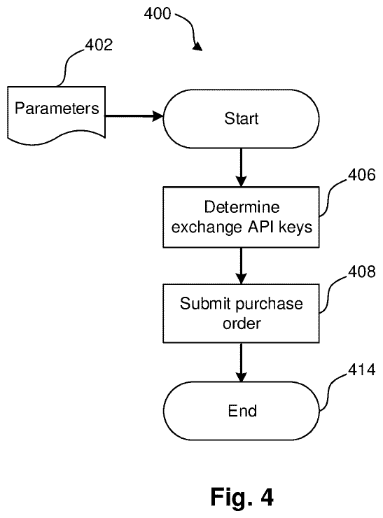

In response to receiving the payment request 160 from the system application 130, the payment system 102 performs a payment process 210 and a purchase process 212, which are detailed further in FIGS. 3 and 4, respectively.

### Payable Amount in Base Currency

In one embodiment, the system application 130 is configured to determine payable amounts with reference to a base currency. The base currency may be a fiat currency, such as United States dollars (USD) or Australian dollars (AUD). Alternatively, the base currency may be a digital currency, such as cryptocurrency Zilliqa (ZIL).

As a output of the operation of the system application 130, the system application 130 transmits a payment request 160 to the payment system 102, which causes the payment system 102 to transfer a payment to a user wallet associated with the user 110. The payment transferred to the user wallet comprises an amount of funds, defined in a user-selected currency, that is equivalent to the payment amount expressed in the base currency as defined in the payment request 160.

### Three Functions

The payment system 102 comprises three functions which work in concert to facilitate the prompt and efficient payment of digital funds to users.

The three functions comprise the payment function 120, the purchase function 122 and the withdraw function 124. The payment function 120 facilitates payment of a payable amount, in the user's selected digital currency, to a wallet 104a-c associated with the user 110. The purchase function 122 facilitates placing purchase orders with a digital currency exchange 144 for digital currency to replenish the amounts paid from the system wallets 106a-d to the user wallets. The withdraw function 124 facilitates the withdrawal of digital funds from the exchange 144 to one or more of the system wallets 106a-d.

In one embodiment, the combined effect of the purchase function 122 and the withdrawal function 124 is to ensure the system wallets 106a-d are replenished with sufficient funds such that each of the system wallets 106a-d contains its respective maintenance amount of funds.

In one embodiment, the payment function 120, the purchase function 122 and the withdraw function 124 are implemented as Amazon Web Services (AWS) Lambda functions. An AWS Lambda function is a software service which executes within the third party service Amazon Web Services.

In one embodiment, the payment system is implemented as one or more software functions executing on one or more processors, or processing devices. It is to be understood that the term processor is not limited to a single processor. A processor may refer to a plurality of processing units, or the software components executing thereon.

### Digital Currency Exchange

The payment system 102 is communicatively connected to one or more digital currency exchanges 144 from which the payment system can facilitate the transfer of an amount of digital currency from the currency exchange 144 into to one or more of the system wallets 106a-d.

In the embodiment illustrated in FIG. 1, the currency exchange 144 comprises a single currency exchange; however, in other embodiments the currency exchange may comprise a plurality of associated or disparate currency exchanges. In one embodiment, the payment system may be in communication with a different currency exchange for each of the different digital currencies supported by the payment system 102.

In one embodiment, the payment system 102 communicates with the currency exchange 144 via an exchange API 142. The exchange API is an application programming interface which enables entities to access an exchange account held with the currency exchange 144. Via the exchange API 142, the payment system 102 can manage one or more digital currency accounts held with the currency exchange 144. For example, the payment system 102 can submit orders to purchase digital currency, submit offers to sell digital currency or withdraw digital currency into one or more of the system wallets 106a-d.

API keys may be used to authenticate users of the API exchange and the currency exchange. In the embodiment illustrated in FIG. 1, the payment system 102 comprises access to a set of API keys 170 which enable the exchange API 142 to authenticate the payment system to access the currency exchange 144. The API keys 170 comprise an API public key and an API private key. The API private key may be referred to as an API secret key. In some embodiments, the API public key performs the function of a username, and uniquely identifies the payment system 102 to the currency exchange 144. In some embodiments, the API private key performs the function of a password or passphrase, and authenticates the entitlement of the payment system 102 to access the currency exchange 144.

When the payment system 102 requests access to the exchange account at the currency exchange 144, the payment system 102 uses the API public key to identify the payment system 102 to the currency exchange 144. The payment system 102 uses the API private key to sign access requests sent from the payment system 102 to the currency exchange 144. In response to the access request being signed with the private API key, the currency exchange 144 considers that the payment system 103 is authenticated to provide access requests to the currency exchange 144.

### Secrets Manager

In one embodiment, the payment system 102 is communicatively connected to a secrets manager 164. In one embodiment, the secrets manager 164 is a third party service which is not part of the payment system 102. In one embodiment, the secrets manager 164 comprises an Amazon Web Services Secrets Manager which is configured to securely maintain confidential information utilised by the payment system 102.

In another embodiment, the secrets manager 164 is a component of the payment system 102. The secrets manager 164 stores private keys 172 associated with each of the system wallets 106a-d. The system manager 164 also stores the API keys 170 associated with access to the currency exchange 144.

To provide enhanced security, a private key associated with each of the system wallets (e.g. private key 172) may be stored across a plurality of storage locations. For example, the private key 172 may comprise a 64-character string of letters or numbers. The 64-character string may be separated into two 32-character sub-keys, wherein each of the sub-keys is stored in a different one of two storage locations. Each storage location may be managed by a different secrets manager. Advantageously, if security provisions are breached for one of the two storage locations, only a portion (e.g. half) of the whole private key may be exposed to the security breach.

The payment system 102 may be configured to retrieve each of the 32-character sub-keys, and concatenate the sub-keys to determine the 64-character private key associated with a system wallet.

### Example Payment

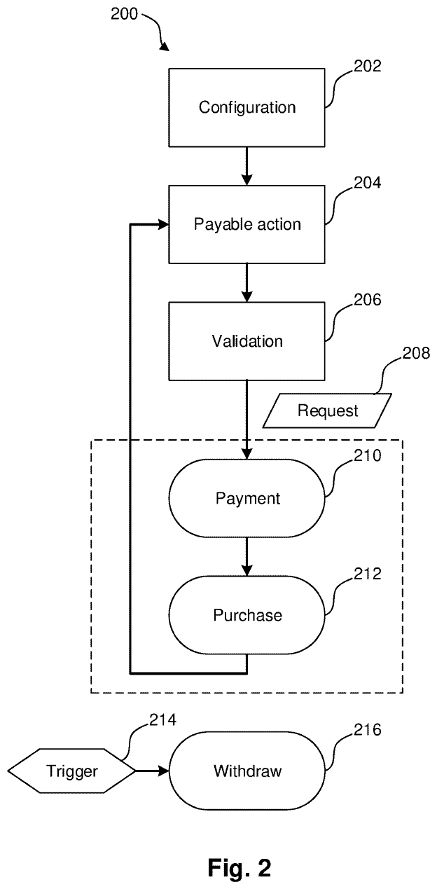

FIGS. 2, 3, 4 and 5 will be described with reference to a non-limiting, non-exhaustive example payment, which is provided only to illustrate an example operation of the payment system 102, in accordance with an embodiment.

The example payment comprises a payment made from the payment system 102 to the user 110. The parameters of the example payment comprise a base currency of United States dollars (USD), a user selected currency of Zilliqa cryptocurrency, a user selected wallet of 104a, and a payable amount of 1.5 USD.

### FIG. 2—Overall Method

FIG. 2 illustrates a method 200, performed partially by the payment system 102 and partially by the system application 130, to facilitate payment of a digital funds to a wallet associated with the user 110, in accordance with an embodiment.

### User Configuration

In operation 202, a user configuration process is performed to configure the user 110 to receive payment from the payment system 102. The user configuration process 202 will be described as being performed by the system application 130; however, it is to be understood that the user configuration process 202 may be performed by the payment system 102, the system application 130, or the payment system 102 in conjunction with the system application 130.

In one embodiment, the configuration process comprises the system application 130 providing the user 110 with a unique identification code that uniquely identifies the user amongst all the users configured to receive payment from the payment system 102. In one embodiment, the configuration process comprises the system application 130 obtaining from the user 110 one or more public keys and/or public addresses associated with one or more user wallets. In one embodiment, the user receives a public address associated with the user's wallet from a third party wallet manager, and provides the public address to the system application 130. In one embodiment, in lieu of receiving a public address of a wallet, the system application 130 causes a new user wallet to be generated for the user. The payment system 102 may provide the public address of the new user wallet to the user. In one embodiment, the user

The configuration process may further comprise providing the user 110 with a selection of a plurality of digital currencies supported by the payment system 102. Digital currencies that are supported by the payment system 102 may comprise digital currencies that are held within system wallets 106a-d. (For example, Zilliqa, IOTA and Doge).

The configuration process may further comprise receiving from the user 110 a selection of a digital currency from the selection of a plurality of digital currencies supported by the payment system. The selected digital currency may be referred to as the user-selected currency.

In one embodiment, the user 110 provides the user configuration information directly to the payment system 102 via a user interface, or graphical user interface (GUI), provided to the user 110 by the payment system 102. In another embodiment, the user 110 provides the user configuration information to the system application 130 via a user interface or GUI provided to the user 110 by the system application 130. In such an embodiment, the system application 130 provides the user configuration information, obtained from the user 110, to the payment system 102.

### Payable Action

In operation 204, the user performs an action, or provides a service, for which the user will receive payment from the payment system 102. The action or service to be performed by the user will depend upon the nature of the system application 130. For example, in an embodiment in which the system application comprises an information analytics platform which collects data from users, the user action may comprise the provision of data to the system application by the user 110.

In one embodiment, in conjunction with performing the payable action, the user 110 provides the system application 130 with an indication of a user-selected currency. In one embodiment, in conjunction with performing the payable action, the user 110 provides the system application 130 with an indication of user digital wallet. In one embodiment, in conjunction with performing the payable action, the user 110 provides the system application 130 with an indication of payable amount.

### Validation

In operation 206, the system application 130 performs a validation process to validate that the user has satisfied the requirements that entitle the user to receive payment from the payment system 102 for performing the payable action in operation 204.

In an example in which the system application 130 comprises an information analytics platform which collects data from users, the validation process may comprise validating that the data provided by the user 110 to the system application 130 is complete and is consistent with previous information provided by the user 110 to the system application 130. In one embodiment, the validation process may comprise verifying the identity of the user 110. The validation process may comprise verifying that the user is entitled to receive payment from the payment system. The validation process may comprise verifying that the user is entitled to receive payment of the payment amount from the payment system. The validation process may comprise verifying that the payment system 102 is able to facilitate payment in the user-selected currency. The validation process may comprise verifying that the payment system 102 is able to facilitate payment of the payable amount.

If the system application 130 validates that the user 110 is entitled to receive payment of the payable amount from the payment system 102, then the system application 130 transmits a payment request 160 to the payment system 102, via the API gateway 136.

In operation 210, the payment function 120 performs a payment process 300, which is described with reference to FIG. 3.

In operation 212, the purchase function 122 performs a purchase process 300, which is described with reference to FIG. 4.

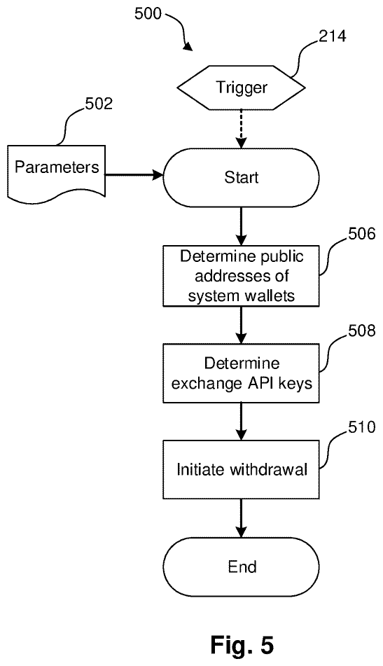

In response to receiving a withdraw trigger 214, the withdraw function 124 performs a withdraw function 500, which is described with reference to FIG. 5.

### FIG. 3—Payment Function

FIG. 3 illustrates a payment method 300, performed by the payment function 120 of the payment system 102, to facilitate payment of a payable amount to the user 110, in accordance with an embodiment.

In one embodiment, the payment function 120 performs the payment method 300 in response to receiving a payment request 160 from the system application 130 via the API gateway 132.

The payment function 120 performs the payment method 300 promptly upon receipt of the payment request 160 from the system application 130 to minimize any fluctuation in the exchange rate between the base currency and the user-selected currency. Furthermore, the payment function 120 performs the payment method 300 automatically upon receipt of the payment request 160 from the system application 130. Advantageously, the payment function 120 does not require input from the user 110 in order to perform the payment method 300. Accordingly, a user receives payment from the payment system without the user having to take action to trigger the payment system to provide payment to the user.

The payment function 120 obtains parameters 302 from the payment request 160. In one embodiment, the parameters 302 comprise an indication of the user-selected currency, a payable amount defined in the base currency and an indication of the user wallet in which to make the payment. The indication of the user wallet may comprise a public key or public address associated with the user wallet.

In operation 306, the payment function 120 communicates with the secrets manager 164 to determine the private key 172 of the system wallet associated with the user-selected currency. With regard to the example payment, the user-selected currency is Zilliqa. Accordingly, the payment function determines the private key 172 of system wallet 106a, which is configured to hold Zilliqa coins.

In operation 308, the payment function 120 communicates with the exchange rate lookup function 162 to determine the exchange rate between the base currency, in which the payable amount has been defined in the payment request 160, and the user-selected currency. With regard to the example payment, the payment function 120 determines that the current exchange rate for Zilliqa is 1 USD: 9.68 ZIL.

In operation 310, the payment function 120 determines, based on the exchange rate determined in operation 308, the payable amount as defined in the user-selected currency, to pay to the user 110. The payable amount defined in the user-selected currency may be referred to as the converted payable amount.

With regard to the example payment, as the payable amount in the base currency is 1.5 USD, the payment function 120 determines that the exchange rate is 1 USD: 9.68 ZIL. Accordingly, payment function 120 determines that the payable amount in the user-selected currency is 14.52 ZIL.

In operation 311, the payment function 120 determines the public key, or public address, associated with the user wallet. The payment function 120 may determine the public key, or public address, associated with the user wallet from the parameters 302.

In operation 312, the payment function 120 transfers the payable amount, defined in the user-selected currency, to the user-selected wallet. The payment function 120 transfers the payable amount to the user-selected wallet by submitting a transfer request to the blockchain node associated with the user-selected currency. The transfer request may comprise an indication of the public key, or public address, associated with the user wallet.

With regard to the example payment, in operation 312, the payment function 120 transfers 14.52 ZIL from system wallet 106a to user wallet 104a, by submitting a transfer via Zilliqa blockchain node 108a

In operation 314, the payment function 120 causes the purchase function 122 to perform the purchase function, as described in relation to FIG. 4.

### Multiple Exchange Rates

In some situations there may be a plurality of currency exchanges which provide currency exchange services for a currency. These currency exchanges may not always offer the same exchange rate for a currency.

For example, cryptocurrency exchange rates can fluctuate on some currency exchanges, while remaining stable on other currency exchanges (outliers). This fluctuation can occur in response to several circumstances, including: a large buy or sell order getting executed on one exchange; volume of a currency being low on an exchange; or volume of a currency being high on an exchange.

In some embodiments, the exchange rate lookup function 162 is configured to determine exchange rates from a plurality of currency exchanges 114. In particular, the exchange rate lookup function is configured to determine a plurality of exchange rates for a currency, wherein each exchange rate of the plurality of exchange rates is associated with a currency exchange of a plurality of currency exchanges 144.

In operation 308, the payment function 120 communicates with the exchange rate lookup function 162 to determine the plurality of exchange rates between the base currency, in which the payable amount has been defined in the payment request 160, and the user-selected currency.

In some embodiments, the payment system 102 is configured to determine the price of a currency, in which a user wants to be paid, by determining a median value of the plurality of exchange rates. In some embodiments, the payment system 102 is configured to determine the median value instead of the mean value because the mean value can be distorted by outlying exchange rate values.

In an example embodiment, a user 110 has elected to be paid in Dogecoin, and the current price of Dogecoin is roughly around $1. In operation 308, the payment system 102, communicates with the exchange rate lookup function, which provides the following plurality of exchange rates from 10 currency exchanges:
$0.995, $1.02, $0.98, $1, $1.01, $0.95, $1.1, $1.3, $0.989, $1.04

Putting these plurality of exchange rates in ascending order, the 5th and 6th values, $1 and $1.01 respectively, are the median values:
$0.95, $0.98, $0.989, $0.995, $1, $1.01, $1.02, $1.04, $1.1, $1.3

In this example, the payment system is configured to determine the exchange rate for Dogecoin, as follows:

(1+1.01)/2=$1.005

In some embodiments, the quality/integrity of prices improves as the exchange rate lookup function 162 determines exchange rates from additional sources of a price feed, such as an additional currency exchange. Current implementation pulls from 10 sources asynchronously.

In some situations, a source of a price feed (e.g. a currency exchange) may not provide an exchange rate back to the exchange rate lookup function 162 in a timely manner (perhaps due to heavy load on their services especially during peak times).

It is often preferable that the payment system does not need to wait too long to receive exchange rate information from the currency exchanges, because exchange rates are often fluctuating in real time and the rate may no longer represent the true/current price of the currency at the time the currency is purchased.

To ameliorate this issue, the payment system 102 may be configured to instruct the exchange rate lookup function 162 to make an asynchronous call, where all sources of a price feed are requested for a price at the same time. The payment system may wait a set period (e.g. 3 seconds) for these calls to return back with an exchange rate. If not all sources are able to return back the exchange rate within the set period, the payment system determines the currency exchange rate based on the exchange rates that were able to be provided to the payment system within the set period.

### Payment Confirmation

In one embodiment, system application 130 displays, in a graphical user interface (GUI), a payment dashboard to the user 110. The payment dashboard comprises a graphical user interface via which a user is able to see and track, details of the currency amounts paid, by the payment system 102, to the user.

The payment dashboard may display a payment confirmation to the user. The payment confirmation may comprise one or more of: a transaction identifier; an amount paid, in terms of a fiat currency; an amount paid, in terms of a cryptographic currency; a unit price (or exchange rate) of the cryptocurrency; a transaction hash; a destination wallet identifier (e.g. a destination address); a time of payment; and date of payment.

### FIG. 4—Purchase Function

FIG. 4 illustrates a purchase method 400, performed by the purchase function 122 of the payment system 102, to submit purchase orders for digital currency with the currency exchange 144, in accordance with an embodiment. The purchase function 122 performs purchase method 400 in response to being triggered by the payment function 120 in operation 314.

The purchase function 122 obtains parameters 402 comprising the user selected digital currency and the payable amount as defined in the user selected digital currency.

In operation 406, the purchase function 122 obtains the API keys 170, which are associated with an exchange account at the digital currency exchange 144. In one embodiment, the purchase function 122 obtains the API keys 170 from the secrets manager 164. The API public and private keys 170 authenticate the payment system 102 with the currency exchange 144 and enable the payment system 102 to submit purchase orders to the digital currency exchange 144.

In operation 408, the purchase function 122 submits a purchase order to the exchange 144 via the exchange API 142. The purchase order comprises a request to purchase the payable amount of funds, as defined in the user selected digital currency. In one embodiment, the purchase order further comprises an exchange rate at which to purchase the payable amount of coins.

With regard to the example payment, in operation 408, the purchase function 122 submits a purchase order to the exchange 144 for 14.52 ZIL coins.

### Purchase Orders

In one embodiment, the purchase order comprises a market order. A market order may enable the payment system 102 to set a price, or a price range, at which the payment system 102 will purchase coins. In some embodiments, a market order enables the payment system 102 to set a purchase price that is equal to, or close to, the current market price of the digital currency.

### Prompt Purchase Order

In one embodiment, the purchase function 122 performs the purchase method 400 promptly in response to the payment function 120 performing the payment method 300. The submission of a purchase order to the currency exchange 144 enables the payment system 102 to purchase cryptocurrency funds instantaneously at market rates.

Advantageously, submitting the purchase order, in operation 408, promptly in response to the payment method 300 may minimize fluctuations in the exchange rate between the base currency, in which the payable amount was defined in the payment request 160, and the user-selected currency.

The purchase order may lock-in the purchase of funds to replenish the system wallet at an exchange rate that is comparable to the exchange rate that was used in operation 308 to determine the payable amount of funds in the user-selected currency. Accordingly, the provided method of submitting purchase orders may ameliorate the effects of the exchange rate volatility that is a common characteristic of cryptocurrencies.

With regard to the example payment, a prompt submission of a purchase order by the payment system 102 to the exchange 144 may enable the payment system 102 to purchase 14.52 ZIL coins at an exchange rate of approximately 1 USD: 9.68 ZIL.

Advantageously, submitting the purchase order, in operation 408, promptly in response to the payment method 300 may reduce the impact of the purchase order on the exchange rate of the currency purchased by the purchase order. In some embodiments, when a purchase order or a sell order is submitted to an exchange, the order may cause the exchange rate of the currency to move. A large purchase, or sell, order may move the exchange rate more than a smaller purchase, or sell, order.

In some embodiments, a currency exchange, or an API associated with the currency exchange, may specify a minimum purchase amount for a currency. In this case, if the purchase function 122 is triggered to purchase XRP and the minimum purchase amount for XRP is $5, the purchase function 122 may make a purchase for $5 in real time when the payment function 120 provides XRP to the user. The purchase function 122 maintains a counter internally of how much extra XRPs the payment system has purchased and then, the purchase function appropriately adjusts the next purchase amount of XRP to account for the extra XRP purchased previously.

For example, if the payment function 120 paid out $2 but the purchase function 122 purchased $5 worth of XRP, the purchase function may not trigger a purchase for the next transfer of $2 since that amount of XRP is already covered in the initial $5 purchase and the system wallet holds the leftover $3 (assuming that XRP price has not changed much between the two transactions). Advantageously, this approach provides a buffer of currency in the system wallet.

In some embodiments, the system application 130 is configured to request the payment system 102 to perform micro payments. A micro payment is a payment in which the payable amount is relatively small. In one example, the payable amount for a micro payment may be equivalent to less than 1 US dollar. In another example, the payable amount for a micro payment may be equivalent to only a few 1 US cents.

In some embodiments, the payment system 102 is configured to process a payment to the users 110 immediately upon receipt of a payment request 160 from the system application 130.

Preferably, the payment system 102 does not collate, or buffer, a plurality of payment requests for a user 110, before providing payment to the user 110. Accordingly, as the payment system 102 is configured to process payment requests 160 and provide payment to users 110 in real-time, the payable amount being paid to the users in each payment transaction is relatively small. In some embodiments, the payable amounts paid to the users by the payment system 102 comprise micro payments. In such embodiments, the purchase order amounts, submitted by the purchase function 122, as a result of the payment function 120 processing the payment request 160, are also micro payments. Consequently, as the amounts being purchased by the payment system 102 from the currency exchange 144 are small, the purchase orders may have less of an effect on the exchange rate (or price) of the purchased currency, compared to larger purchase orders. Similarly, purchase orders for micro amounts may be less likely to adversely affect the liquidity of the purchased currency. As liquidity of a currency can affect the exchange rate of the currency, a system that submits purchase orders for small or micro amounts may ameliorate the risk of effecting the exchange rate of the currency.

### FIG. 5—Withdraw Function

FIG. 5 illustrates a withdraw method 500, performed by the withdraw function 124 of the payment system 102, to withdraw digital currency from the exchange 144, in accordance with an embodiment. In one embodiment, the payment system 102 may comprise separate withdraw functions for each of the system wallets 106 supported by the payment system 102.

In the embodiment illustrated in FIG. 1, the payment system comprises a single withdraw function, which functions to withdraw funds from the exchange 144 to replenish each of the supported system wallets 106a-d.

In operation 504, the withdraw function 124 receives parameters 502 which define the operation of the withdraw method 500. In one embodiment, the parameters 502 comprise a list of the system wallets for which the withdraw function is to be performed, and for each of the system wallets for which the withdraw function is to be performed, an indication of how much currency is to be withdrawn to replenish the system wallet.

The indication of how much currency is to be withdrawn may comprise a total of the amounts paid from the system wallet since the withdraw function has last been performed, a current balance of the system wallet, a target balance of the system wallet, or some other indication of how much currency is to be withdrawn to replenish the system wallet.

In operation 506, the withdraw function 124 determines the public address of each of the system wallets indicated in the parameters 502.

In operation 508, the withdraw function 124 determines the API keys 170 associated with the currency exchange 144. In one embodiment, the withdraw function 124 determines the API keys 170 associated with the currency exchange 144 by requesting and retrieving the API keys from the secrets manager 164. The API public and private keys 170 authenticate the payment system 102 with the currency exchange 144 and enable the payment system 102 to submit purchase orders to the digital currency exchange 144.

### Multiple Payments

In one embodiment, the payment system 102 facilitates multiple payments of funds to user wallets before the withdraw function 124 performs the withdraw process 500.

In one embodiment, the payment system 102 transfers a first amount from a system wallet to a user wallet. Then the payment system 102 transmits a purchase order for the first amount to the digital currency exchange 144. The payment system 102 may then transfer a second amount from the system wallet to the user wallet. The user wallet receiving the second amount may be the same as, or different to, the user wallet receiving the first amount. The payment system 102 may then transmit a second purchase order for the second amount to the digital currency exchange 144.

At some time later, in response to a withdraw trigger, the payment system 102 may perform process 500 to withdraw a withdrawal amount from the digital currency exchange 144 to the system wallet. The withdrawal amount may be associated with the first purchase order and the second purchase order. In one embodiment, the withdrawal amount is equal to the sum total of the first purchase order and the second purchase order.

### Trigger for Withdraw Function

In one embodiment, the trigger 214 for performing the withdraw method 500 is controlled by a job scheduler such as a cron command line utility (otherwise called a cron job). The trigger 214 may comprise a time of the day, or a date. For example, the cron job may be configured to trigger the withdraw method 500 once per day, at midnight.

In one embodiment, the trigger 214 may comprise a minimum balance amount of a system wallet. For example, the cron job may be configured to trigger the withdraw method 500 when the balance of the system wallet 106a is below 1,000 ZILs.

In one embodiment, the trigger 214 may comprise one or any combination of: a time of the day; a number of payments made from the payer digital wallet; a total amount of transfers from the payer digital wallet; a balance associated with the payer digital wallet; a cost associated with withdrawing the withdrawal amount from the digital currency exchange; or an indication that a balance of digital funds stored by the digital wallet is less than a minimum balance of digital funds.

Digital exchange application, such as exchange 144, typically charge fees associated with each withdrawal of funds from the exchange. Advantageously, configuring a withdraw trigger that generates after a plurality of purchase orders have been placed by the purchase function 122, may reduce the amount of fees payable to the exchange 144.

### System Scalability

The payment system 102 may be considered as a system of two parts operating substantially in parallel to facilitate scalability and to ameliorate the effects of exchange rate volatility and transaction costs. A first part of the payment system 102 comprises the payment function 120 and the purchase function 122, which are triggered in response to receiving a payment request 160.

A second part of the payment system 102 comprises the withdraw function 124, which is triggered by a withdraw trigger. The withdraw trigger may be generated independent of the receipt of a payment request 160.

Bridging the first part and the second part of the payment system 102 are the system wallets 106a-d. The system wallets 106a-d provide a working buffer (or a working balance) of digital currency funds to fulfil payment requests received from the system application 130. The working buffer held by the system wallets 106a-d is managed by the withdraw function 124.

In one example, the first part of the payment function 120 may be generated, in response to receiving individual payment requests, at numerous times, at irregular intervals, and for various payable amounts, over the course of a period of time. Payment requests may be fulfilled by funds held in the system wallets 106a-d.

If the withdraw function 124 was also generated in response to receiving individual payment requests, at numerous times, at irregular intervals, and for various payable amounts, over the course of a period of time, the transaction costs associated with the numerous withdrawals from the currency exchange may be too high to enable sustainable operation of the payment system 102. Transaction costs may comprise monetary fees associated with a transaction, or system operation costs associated with operation of the withdraw function 124 or communication with the currency exchange 144.

However, in an example in which the triggering of the withdraw function 124 is independent of the receipt of a payment request 160 (for example, the withdraw trigger is generated at a set time every 24 hour period, or the withdraw trigger is generated with the aim of minimising currency exchange fees, or the withdraw trigger is generated at a time that minimises system operation costs), the transaction costs associated with the withdraw function are not a direct function of the characteristics of the numerous payments requests received.

The insulation of the transaction costs from the variabilities associated with receipt of the payment requests 160, may enable the payment system 102 to scale operation sustainably.

Furthermore, the working buffer provided by the system wallets 106a-d, and the operation of the withdraw function 124 as independent from the operation of the payment function and purchase functions, may provide increased regulation of the currency exchange transaction costs incurred by the operation of the payment system 102.

Advantageously, the working buffer provided by the system wallets 106a-d may enable the payment system 102 to continue to fulfil payment requests 150, in the event that the payment system 102 is unable to access funds from the currency exchange 144.

### System Platform

In one embodiment, the payment system 102 comprises machine-readable instructions, code, software or firmware. In one embodiment, the payment system 102 comprises machine-readable code configured to execute on one or more servers. In one embodiment, the payment system 102 comprises a plurality of functions configured to execute within a serverless computer service. In one embodiment, the serverless computing service comprises AWS Lambda, which is provided by Amazon Web Services. In one embodiment, the computing service comprises an AWS Elastic Compute Cloud (EC2), which is provided by Amazon Web Services.

In one embodiment, the system APIs are written in JavaScript and Express JS, which is a back end web application framework, is used for providing web service.

In one embodiment, the high uptime (or availability) of the serverless computing service facilitates the continuity of operation of the payment system 102. In one embodiment, the serverless computing service provides a charging model in which charges are incurred only for the time that the functions of the payment system 102 execute on the computing service.

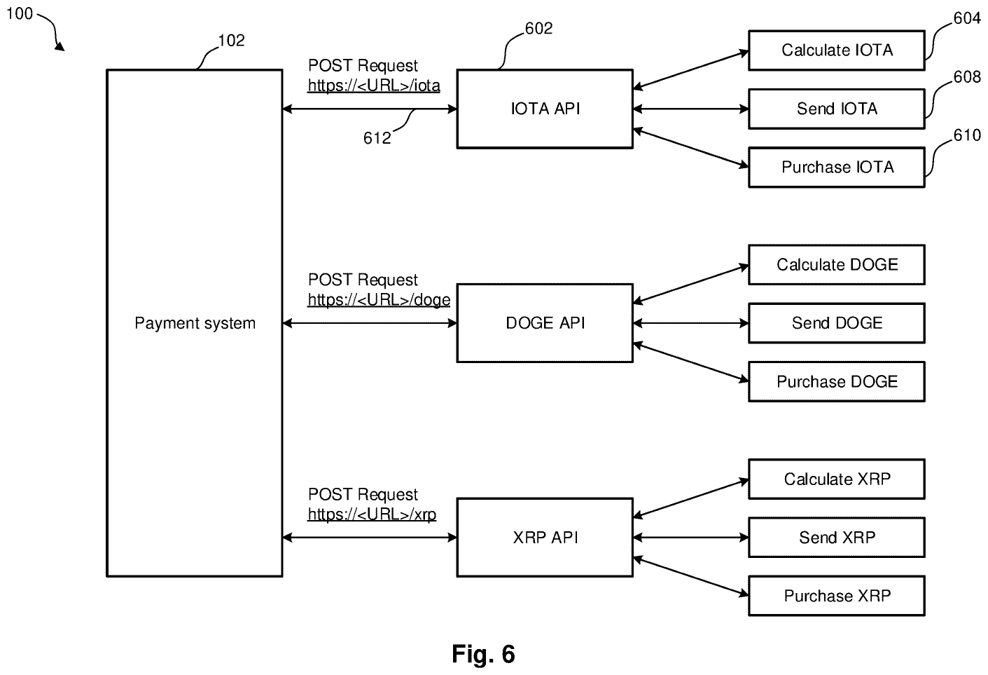

### FIG. 6—Cryptocurrency Blockchain APIs

FIG. 6 illustrates an API architecture for a plurality of blockchain nodes, each associated with a cryptocurrency, according to an embodiment.

In one embodiment, each cryptographic currency node has its own API, and the payment function 120 is configured to submit a transfer request to the blockchain node associated with the user-selected currency via the API for that user-selected currency. For example, the payment system 102 is configured to send a POST request 612 to the IOTA node 602 via a Uniform Resource Locator (URL) associated with the IOTA node. The IOTA node 602 may be configured to perform one or more of: an exchange rate calculation function 604; a currency transfer function 608; and a currency purchase function 610.

The POST request 612 may comprise a header including an authentication token. The authentication token comprises a secret key stored in the secrets manager (e.g. AWS Secrets Manager).

The POST request 612 may comprise a request body, which includes: a destination address; and a payable amount defined in the base currency.

### Example Market Order

In one embodiment, the payment system 102 submits a market order via execution of the following code:

```
order = client.order_market_buy(
  symbol=‘BNBBTC’,
  quantity=100)
order = client.order_market_sell(
  symbol=‘BNBBTC’,
  quantity=100)
```

### Example Withdrawal Function

In one embodiment, the withdraw function 124 comprises an AWS Lambda function. The Lambda function utilises the Python Binance library to enable the withdrawal of funds from the digital exchange 144.

The Lambda function first checks the current balance in the Spot account of Binance for XRP, ZIL, IOTA and Doge. If the balance is greater than 0, it will initiate a withdrawal request as below:

```
# get balance for a specific asset only (BTC)
print(client.get_asset_balance(asset=‘BTC’))
# withdraw 100 ETH
# check docs for assumptions around withdrawals
from binance.exceptions import BinanceAPIException
try:
  result = client.withdraw(
    asset=‘ETH’,
    address=‘<eth_address>’,
    amount=100)
except BinanceAPIException as e:
  print(e)
else:
  print(“Success”)
```

The public address of the system wallets 106a-d will be accessible in the withdraw Lambda function 124 from the AWS Secret Manager 164. The asset value defines the selected cryptocurrency and can be XRP, ZIL, IOTA or DOGE. The address will be the public address of the specific system wallet 106a-d associated with the selected cryptocurrency. The amount will be the full balance being withdrawn from the spot wallet for the selected cryptocurrency in Binance.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

“The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited.”

1-20. (canceled)

21. A computer-implemented method for facilitating a transfer of funds of a selected digital currency, the funds being transferred from one of a plurality of payer digital wallets, each of the plurality of payer digital wallets configured to store funds defined by a respective different one of a plurality of digital currencies, the method comprising:
determining a payable amount, the payable amount being defined in a first currency;
determining an indication of a selected digital currency;
selecting one of the plurality of payer digital wallets based on the selected digital currency, the selected payer digital wallet being configured to store digital funds defined by the selected digital currency;
receiving an indication of a payee digital wallet, the payee digital wallet configured to store funds defined by the selected digital currency;
determining, based on the payable amount defined in the first currency, a converted payable amount defined in the selected digital currency; and
transferring the converted payable amount from the selected payer digital wallet to the payee digital wallet.

22. The method of claim 21, wherein determining a converted payable amount defined in the selected digital currency comprises determining an exchange rate between the first currency and the selected digital currency.

23. The method of claim 21, further comprising:
transmitting a first purchase order for the converted payable amount to a digital currency exchange;
transferring a second amount from the selected payer digital wallet to a second payee digital wallet;
transmitting a second purchase order for the second amount to the digital currency exchange; and
in response to a withdraw trigger, withdraw a withdrawal amount from the digital currency exchange to the selected payer digital wallet, the withdrawal amount being associated with the first purchase order and the second purchase order.

24. The method of claim 23, wherein the withdraw trigger comprises any one or a combination of:
a time of the day;
a number of payments made from the payer digital wallet;
a total amount of transfers from the payer digital wallet;
a balance associated with the payer digital wallet;
a cost associated with withdrawing the withdrawal amount from the digital currency exchange; and/or
an indication that a balance of digital funds stored by the digital wallet is less than a minimum balance of digital funds.

25. The method of claim 23, wherein the payee digital wallet is the same as the second payee digital wallet.

26. The method of claim 21, wherein the selected digital currency comprises a cryptocurrency.

27. The method of claim 21, wherein the first currency is a fiat currency.

28. The method of claim 21, wherein the transfer of the converted payable amount from the selected payer digital wallet to the payee digital wallet is recorded in a distributed ledger.

29. The method of claim 21, wherein each of the plurality of payer digital wallets is associated with a respective maintenance amount of digital funds in the digital currency associated with the respective payer digital wallet.

30. The method of claim 21, further comprising:
in response to transferring the converted payable amount from the selected payer digital wallet to the payee digital wallet, facilitate a transfer of funds to the selected payer digital wallet to ensure an amount of funds stored by the selected payer digital wallet is equal to, or exceeds, the maintenance amount associated with the selected payer digital wallet.

31. The method of claim 21, further comprising a validation process, the validation process comprising:
receiving a payment request;
performing a validation process; and
in response to performing the validation process, providing an indication of validation to the processor.

32. The method of claim 31, further comprising, in response to receiving an indication of validation from the validation component, transferring the converted payable amount from the selected digital wallet to the payee digital wallet.

33. A computer program comprising machine-readable instructions to cause a processing device to implement a method for facilitating a transfer of funds of a selected digital currency, the funds being transferred from one of a plurality of payer digital wallets, each of the plurality of payer digital wallets configured to store funds defined by a respective different one of a plurality of digital currencies, the method comprising:
determining a payable amount, the payable amount being defined in a first currency;
determining an indication of a selected digital currency;
selecting one of the plurality of payer digital wallets based on the selected digital currency, the selected payer digital wallet being configured to store digital funds defined by the selected digital currency;
receiving an indication of a payee digital wallet, the payee digital wallet configured to store funds defined by the selected digital currency;
determining, based on the payable amount defined in the first currency, a converted payable amount defined in the selected digital currency; and
transferring the converted payable amount from the selected payer digital wallet to the payee digital wallet.

34. A system for facilitating a transaction of funds of a selected digital currency, the system comprising:
a plurality of payer digital wallets, each of the plurality of payer digital wallets configured to store digital funds defined by a respective different one of a plurality of digital currencies; and
a processor configured to:
determine a payable amount, the payable amount being defined in a first currency;
determine an indication of the selected digital currency;
select one of the plurality of payer digital wallets based on the selected digital currency, the selected payer digital wallet being configured to store digital funds defined by the selected digital currency;
receive an indication of a payee digital wallet, the payee digital wallet configured to store funds defined by the selected digital currency;
determine, based on the payable amount defined in the first currency, a converted payable amount defined in the selected digital currency; and
transfer the converted payable amount from the selected payer digital wallet to the payee digital wallet.

35. A system of claim 34 further comprising:
an interface to a digital currency exchange;
the processor further configured to:
transmit a first purchase order for the converted payable amount to the digital currency exchange via the interface;
transfer a second amount from the payer digital wallet to a second payee digital wallet;
transmit a second purchase order for the second amount to the digital currency exchange via the interface; and
in response to a withdraw trigger, withdraw a withdrawal amount from the digital currency exchange to the payer digital wallet, the withdrawal amount being associated with the first purchase order and the second purchase order.

36. The system of claim 35, wherein the processor is further configured to generate the withdraw trigger.

37. The system of claim 34, wherein the selected digital currency comprises a cryptocurrency.

38. The system of claim 34, further comprising a plurality of cryptocurrency nodes, each of the plurality of cryptocurrency nodes associated with a respective one of the plurality of payer digital wallets.
